(19) United States
(12) Patent Application Publication
(10) Pub. No.: US 2007/0214035 A1
(43) Pub. Date: Sep. 13, 2007

(54) CASUAL PERSONNEL RECRUITMENT METHOD AND SYSTEM

(76) Inventors: Damien Walsh, Victoria (AU); Barbara Walsh, Victoria (AU)

Correspondence Address: HOVEY WILLIAMS LLP, 2405 GRAND BLVD., SUITE 400, KANSAS CITY, MO, 64108, US

(21) Appl. No.: 11/687,143

(22) Filed: Mar. 16, 2007

Related U.S. Application Data
(63) Continuation of application No. PCT/AU05/01411, filed on Jul. 13, 2005.

(30) Foreign Application Priority Data
Sep. 17, 2004 (AU) AU2004905463
Jan. 17, 2005 (AU) AU2005900183

(51) Int. Cl. G06F 15/02

(52) U.S. Cl. 705/9

(57) ABSTRACT

A method and system is provided for recruitment and management of casual personnel via a telecommunications network. One or more casual employees register a job seeker profile including details of the casual employee's availability in a database. A prospective employer nominates search criteria including a date and/or time when the casual employee is required to work for interrogation of the database. A list of casual employees meeting the employer nominated search criteria is generated. The prospective employer selects one or more casual employees form the list and initiates contact with selected casual employees using an instant communication pathway. Methods and systems are also provided for monitoring the time worked by a casual employee for an employer.

This application is a continuation-in-part of International patent application PCT/AU2005/001411 the entire contents of which are herein incorporated by reference.

### FIELD OF THE INVENTION

The present invention relates generally to a method for recruiting and managing personnel and more particularly to a method and system for recruiting and managing casual personnel using a telecommunications network.

### BACKGROUND TO THE INVENTION

Service industries including the retail, hospitality and clerical sectors and industries subject to seasonal fluctuations such as the agriculture and tourism sectors traditionally rely on a largely casual workforce. Even those businesses that rely largely on a permanent workforce may require access to casual staff from time to time to accommodate sickness, annual leave or to assist permanent staff in coping with periods of increased demand.

In terms of recruitment strategies, the needs of businesses that require access to casual workers differ from those of businesses which employ a more permanent workforce. Businesses employing a casual workforce are likely to require additional staff at short notice. A number of resources exist to assist prospective employers in finding suitable candidates to fill available positions.

One common recruiting method is to place an advertisement in the employment section of a newspaper or a magazine that is targeted at people having particular interests or skills. Applicants apply for the advertised position by sending a resume directly to the prospective employer by mail, facsimile or electronic mail. The prospective employer reviews the applications and interviews those candidates which the employer believes will best suit the requirements of the position. The prospective employer makes a decision based on the candidate's performance and credentials. This approach to recruitment is labour intensive for both the prospective employee and the job seeker. Moreover, it is not possible to recruit staff at short notice since there is a delay between an advertisement being submitted for publication in the employment section of a newspaper or magazine and distribution of that publication.

Alternatively, a prospective employer may engage an agency offering specialist recruitment services. Many such agencies specialise in recruiting staff for particular industries and some specialise in placing temporary or casual staff. The role of the recruitment agency is usually to advertise the position, pre screen and interview candidates on behalf of a prospective employer. Enlisting a recruitment agency can save the business time but tends to be costly. In the case of agencies which place temporary or casual staff, it is typical for the agency to earn a commission based on a percentage of the hourly rate that the employer pays the casual worker recruited via the agency. Enlisting the help of a recruitment agency also has the drawback that there is a delay between instructing an agency to find workers to fill a particular shift and those workers actually presenting to the employer to work. Whilst some temporary and casual recruitment specialist aim to offer a faster turnaround service, such agencies are generally not accessible after conventional business hours including weekends and public holidays which are generally the busiest times for service industries such as the hospitality industry.

Another continuing issue for employers of casual personnel is the necessity for monitoring and recording the time worked by the casual employee in each work session to enable the correct calculation of the wages and benefits to be payed to the casual employee. In the event that a casual employee has been recruited via a recruitment agency, the time worked by the casual employee for the employer in each work session must be recorded, verified and transmitted to the recruitment agency, so that the recruitment agency can calculate not only the benefits to paid to the employee, but also the correct fees to be charged to the employer. In this instance desirably both the employer and the casual employee confirm the number of hours worked by the casual employee, so that there is no discrepancy. Typically the casual employee fills in a time sheet which is signed by an authorised representative of the employer and transmitted to the recruitment agency. Delay in payment may be experienced if the employee or employer does not complete a timesheet in a timely manner.

It would therefore be desirable to provide a new, easy to use and innovative approach to recruiting and managing casual staff.

### SUMMARY OF THE INVENTION

According to an aspect of the present invention, there is provided a method for recruiting and managing casual personnel via a telecommunications network, the method including the following steps:
(a) one or more casual employees registering a job seeker profile in a database, each job seeker profile including details of the casual employee's availability;
(b) a prospective employer nominating search criteria for interrogation of the database, the search criteria including a date and/or time when the casual employee is required to work;
(c) generating a list of casual employees having a job seeker profile that matches the employer nominated search criteria;
(d) the prospective employer selecting one or more casual employees from the list; and
(e) the prospective employer initiating contact with the selected casual employees using an instant communication pathway.

The prospective employer may make the section of one or more casual employees based on a review of the job seeker profiles corresponding to the casual employees on the generated list.

Preferably, contact between the prospective employer and the selected casual employees is initiated by transmitting a message to each of the selected casual employees, the message prompting the casual employee to contact with the prospective employer on an expedited basis.

In one particular embodiment, following selection of a casual employee by the prospective employer from the list of casual employees, the casual employee's contact details are transmitted to the prospective employer in return for a fee.

According to another aspect of the present invention, there is provided a method of recruiting and managing casual personnel via a telecommunications network, the method including the following steps:
(a) one or more casual employees registering a job seeker profile in a database, each job seeker profile including details of the casual employee's availability;
(b) a prospective employer nominating search criteria for interrogation of the database, the search criteria including a date and/or time when the casual employee is required to work;
(c) generating a list of casual employees having a job seeker profile that matches the employer nominated search criteria;
(d) the prospective employer initiating contact with one or more of the listed casual employees using an instant communication pathway;
(e) monitoring the time worked by the casual employee for the employer by the casual employee receiving a text message after a planned work session, the text message requesting confirmation of the time worked in the work session, the casual employee replying to the text message to confirm details of the work session, and the employer confirming details of the work session.

Preferably, the casual employee receives and responds to the text message using a mobile communications device which receives and transmits the text messages.

More preferably, the employer confirms details of the work session by entering a code onto the casual employee's mobile communications device.

According to another aspect of the present invention, there is provided a system for recruiting and managing casual personnel via a telecommunications network, the system including:
(a) a registration component for entering a casual employee's job seeker profile including details of the casual employee's availability;
(b) a database for storing a plurality of job seeker profiles;
(c) a search criteria selection component which enables a prospective employer to nominate search criteria for interrogation of the database, the search criteria including a date and time when the casual employee is required to work;
(d) a search engine for identifying casual employees having a job seeker profile that matches the employer nominated search criteria;
(e) a selection component to enable the prospective employer to select one or more identified casual employees that the prospective employer wishes to contact; and
(f) a communication component for initiating contact between the prospective employer and one or more selected casual employees using an instant communication pathway.

In one embodiment of the invention, the instant communication pathway includes a short message service (SMS) text messaging facility to enable a text message including a contact telephone number for the prospective employer to be transmitted to the casual employee. SMS, also known as text messaging, is a well known service which permits the sending of short messages of digital information convertible into human readable text between mobile phones, other handheld electronic devices such as pocket-sized personal computers, desktop computers, and other communications devices.

In an alternative embodiment, the instant communication pathway includes an electronic mail messaging facility in which a contact telephone number for the prospective employer is transmitted to the job seeker via email, with an instant alert such as an SMS message notifying the job seeker on receipt of the email.

In yet another form of the invention, the instant communication pathway includes a recorded message including a contact telephone number for the prospective employer. The instant communication pathway may alternatively include an interactive voice response system enabling the job seeker to be offered an option of being connected directly with the prospective employer.

The system may further include a billing component to enable a system operator to charge the prospective employer for transmission of the casual employee's contact details.

According to still another aspect of the present invention, there is provided a system for recruiting and managing casual personnel via a telecommunications network, the system including:
(a) a registration component for entering a casual employee's job seeker profile including details of the casual employee's availability;
(b) a database for storing a plurality of job seeker profiles;
(c) a search criteria selection component which enables a prospective employer to nominate search criteria for interrogation of the database, the search criteria including a date and time when the casual employee is required to work;
(d) a search engine for identifying casual employees having a job seeker profile that matches the employer nominated search criteria;
(e) a communication component for initiating contact between the prospective employer and an identified casual employee using an instant communication pathway; and
(f) a monitoring component for sending a text message to the casual employee after a planned work session, receiving from the casual employee a text message to confirm details of the work session, and receiving from the employer confirmation of details of the work session.

Preferably, the communication component includes a mobile communications device which receives and transmits the text messages.

More preferably, the employer confirms details of the work session by entering a code onto the casual employee's mobile communications device.

According to yet another aspect of the present invention, there is provided an internet site for recruiting and managing casual personnel via the internet, including:
(a) a registration component for entering a casual employee's job seeker profile including details of the casual employee's availability;
(b) a database for storing a plurality of job seeker profiles;
(c) a search criteria selection component which enables a prospective employer to nominate search criteria for interrogation of the database, the search criteria including a date and time when the casual employee is required to work;
(d) a search engine for identifying casual employees having a job seeker profile and that that matches the employer nominated search criteria;
(e) a messaging component for transmitting a message using an instant communication pathway, the message prompting the casual employee to expeditiously initiate contact with the prospective employer business;
(f) a communication component enabling the casual employee to initiate contact with the prospective employer; and
(g) a monitoring component for monitoring the time worked by the casual employee for the employer.

In an embodiment, the time worked by the casual employee for the employer is monitored by:
(a) the casual employee receiving a text message after a planned work session, the text message requesting confirmation of the time work in the work session;
(b) the casual employee replying to the text message to confirm details of the work session; and
(c) the employer confirming details of the work session.

An advantage of the invention is to provide a cost effective and reliable means for businesses to recruit casual staff.

Another advantage of the invention is to enable casuals to obtain work at their discretion.

Yet another advantage of the invention is to assist the service industry in accessing experienced casuals, at minimal cost.

### BRIEF DESCRIPTION OF DRAWINGS

The invention will now be described in further detail by reference to the enclosed drawings illustrating preferred forms of the invention. It is to be understood that the particularity of the drawings does not supersede the generality of the preceding description of the invention. In the drawings:

FIG. 1 is a schematic overview of a casual employment system according to an embodiment of the invention.

FIG. 2 is a flow chart showing an overview of the method of recruiting casual personnel according to one embodiment of the present invention.

FIG. 3 is a screen view of an internet site for recruitment of casual personnel via the internet according to an embodiment of the present invention.

FIG. 4 is a screen view of a casual job seeker registration facility provided on the internet site of FIG. 3.

FIG. 5 is a screen view of a business membership registration facility provided on the internet site of FIG. 3.

FIG. 6 is a screen view of a search facility provided on the internet site of FIG. 3.

FIG. 7 is a flow chart showing an overview of the method of recruiting casual personnel and monitoring time worked according to another embodiment of the present invention.

### DETAILED DESCRIPTION

A casual personnel system is provided for access via a telecommunications network such as the internet, to enable businesses to recruit and manage casual employees. In the context of the description of the system the term “casual” is taken to refer to an occasional member of staff who is engaged and paid on an hourly or sessional basis. Casuals may include contract or freelance workers.

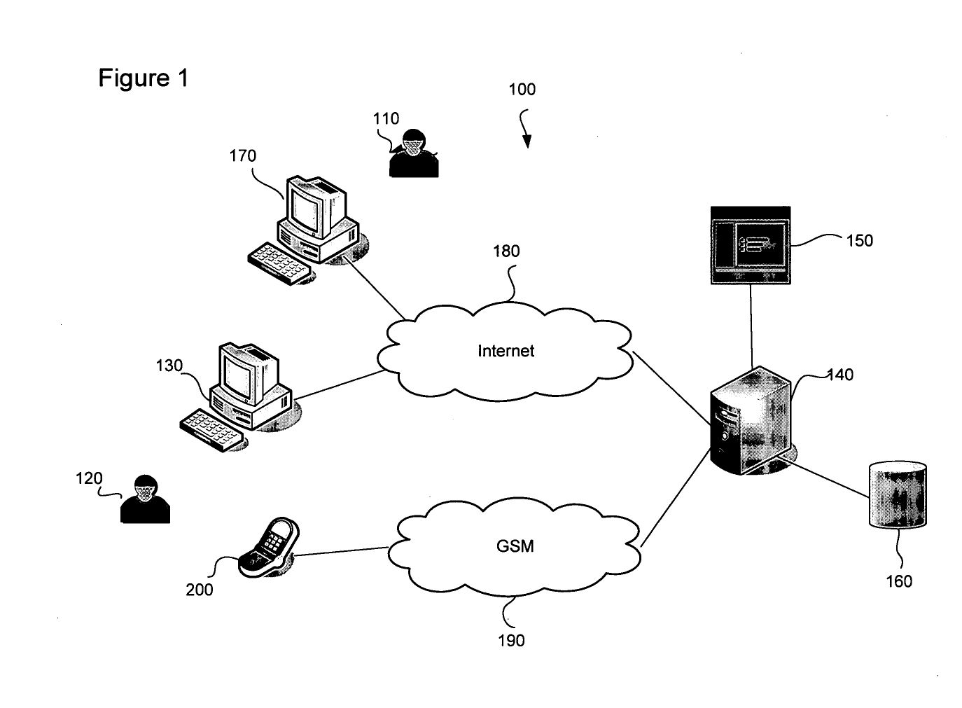

Referring firstly to FIG. 1, there is provided a system 100 to facilitate an employer 110 recruiting and managing one or more casual employees 120. In a first embodiment, the system 100 includes a client user terminal 130 for access by a casual employee 120, in communication with a server 140 associated with a remote recruitment service 150. Server 140 may be associated with a database 160 for storing job seeker profiles associated with a plurality of casual employees 120. The employer 110 nominates search criteria for interrogating the database 160 using user terminal 170. The client user terminals 120 and 170 and server 140 are interconnected by means of the internet 180 or any other suitable communications network.

Remote recruitment service 150 transmits a message to one or more casual employees 120 whose job seeker profile matches the search criteria nominated by the employer 110, using an instant communication pathway 190. In a preferred embodiment, the instant communication pathway 190 is a mobile communications network such as a GSM network. GSM network is the well known abbreviation for Global System for Mobile communications and is currently a popular standard for wireless communications networks. Accordingly, the message is preferably sent to a mobile communications device 200 such as mobile telephone associated with the casual employee 120 as a short message service (SMS) text message.

In an alternative embodiment, it is envisaged that a casual employee can access the system using a mobile communications device 200 such that the casual employee can update their job seeker profile and the like without requiring access to a computer terminal. In a similar fashion, the employer can access the system to nominate search criteria for interrogation of the database using a mobile communications device. This enables an employee to utilise the system to recruit staff at short notice even when the employee is away form the office, e.g. on-site, and does not have access to a computer terminal. The system then transmits the search results to the employer's communications device, e.g. as a short message service (SMS) text, in accordance with preferences saved in an employer profile.

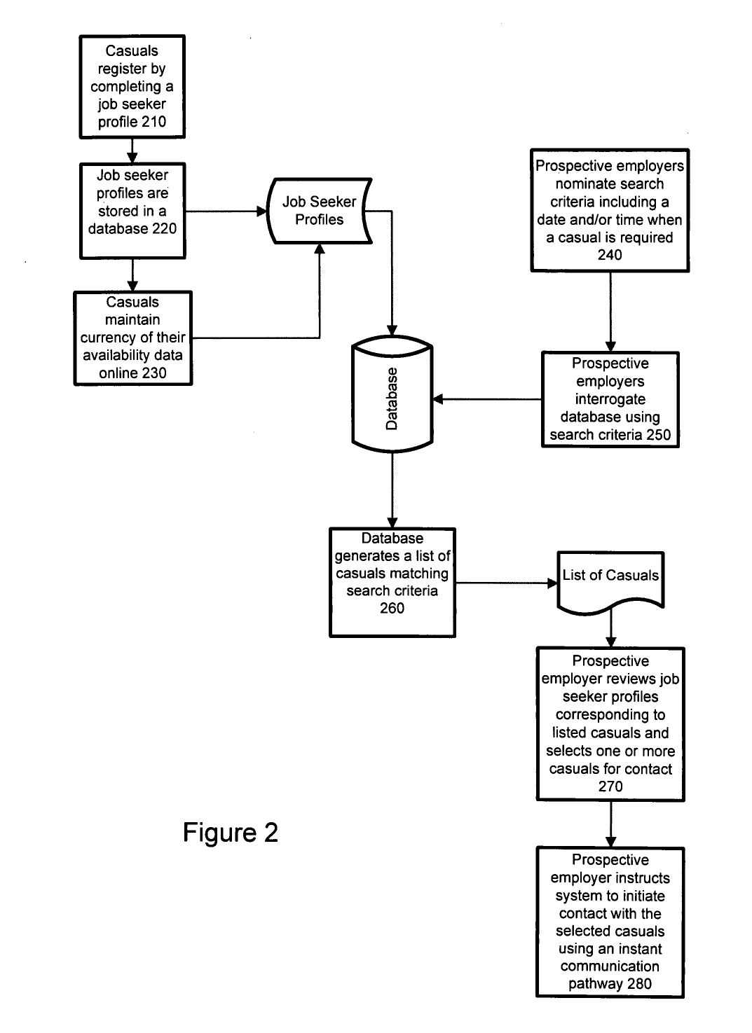

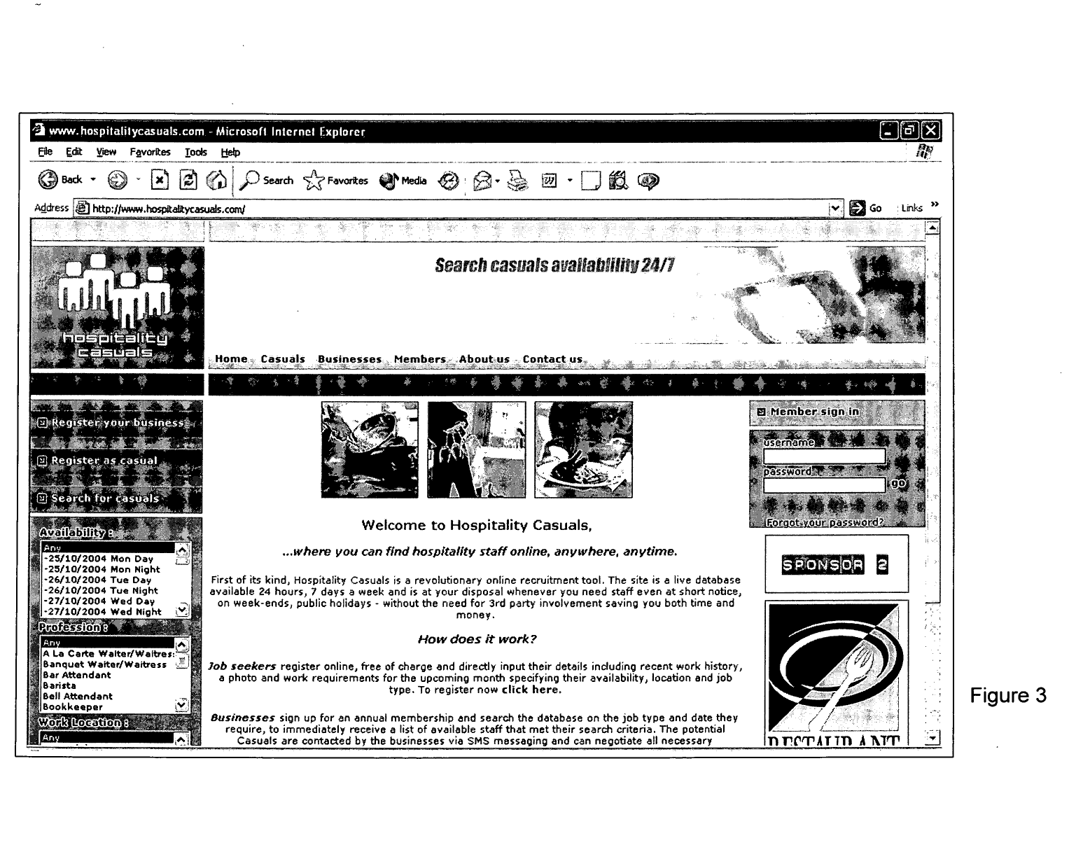

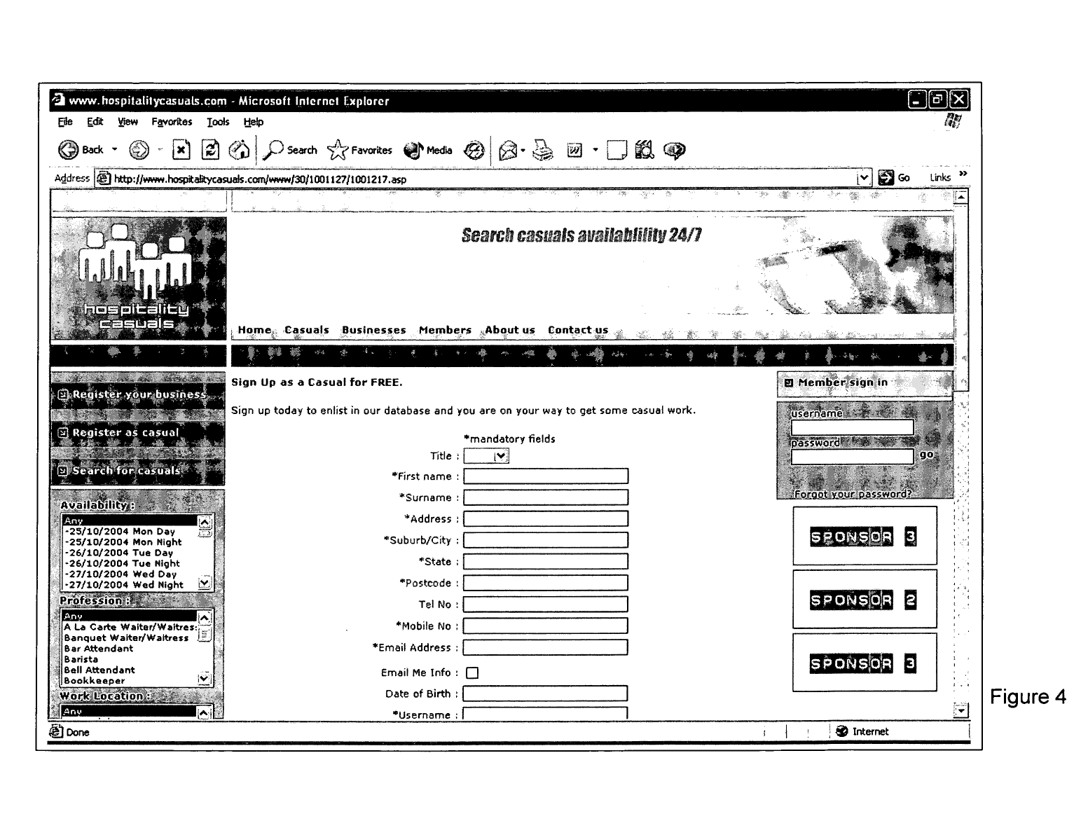

Referring now to FIG. 2, casual employees register with the recruitment system 100 by completing a job seeker profile 210. The casual employee 120 accesses the system 100 via a telecommunications network such as the internet 180. One particular embodiment is illustrated in FIG. 3 which shows a screen view of an internet site. The casual employee 120 enters his or her details in an input form as shown in FIG. 4 to enable the system 100 to generate a job seeker profile. The job seeker profile includes details such as the employee's photograph, name, position that the job seeker is skilled for, age, location and contact details, ABN (Australian Business Number) or other business identifying code, and business name (if applicable) and details of previous work experience. In addition employees may attach a copy of their curriculum vitae. In one particular embodiment, a casual employee attaches a video file including a brief segment which introduces the casual employee and provides some information about them. The video file can be viewed simply by clicking on a link associated with the name of the casual employee. The employee's contact details should include a mobile telephone number so that the employee 120 can be contacted at short notice. The completed job seeker profile is stored in a database 220.

Once the casual employee 120 is registered with the system 100, the employee accesses the system on a regular basis to update their availability to work 230. The casual employee 120 may also choose how far they are prepared to travel for a job by nominating the suburbs and/or areas in which they are available to work. The casual employee 120 may also indicate for which particular employers 110 he or she is prepared to work. Casual employees 120 can update details such as availability, the types of positions the job seeker is seeking or is qualified to do, and the locations that the employee would like to work in, instantly online.

Employers 110 associated with the system that have previously employed a particular casual employee 120 may provide comments and/or a rating for the casual employee. For example, the casual employee 120 could be rated on a scale of one to five stars based on his or her previous performance. Alternatively, the system administrator may provide a curriculum vitae checking service such that a list of casual employees indicates which registered casual employees have had their curriculum vitae checked and those which have not.

Once a casual employee 120 is registered and has ensured that their availability is up to date, their details can be accessed by prospective employees 110 who search the system for casual employees who are available to work at certain nominated dates and/or times. If a prospective employer 110 is interested in discussing a position with a casual employee 120 in more detail or wishes to offer a position to a casual employee after reviewing their details online, the prospective employer instructs the system 100 to contact the casual employee using an instant communication pathway 180. The prospective employer and casual employee are therefore enabled to directly discuss the position in more detail and negotiate the terms and conditions under which the casual employee would be employed.

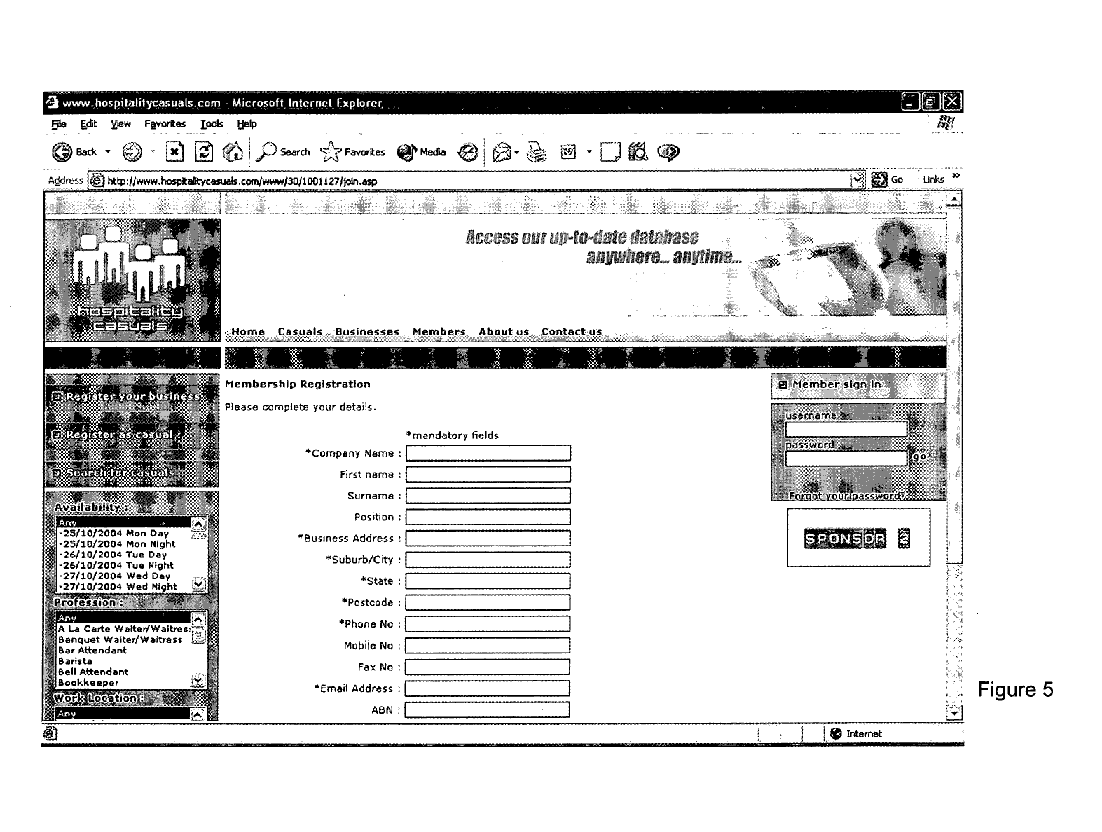

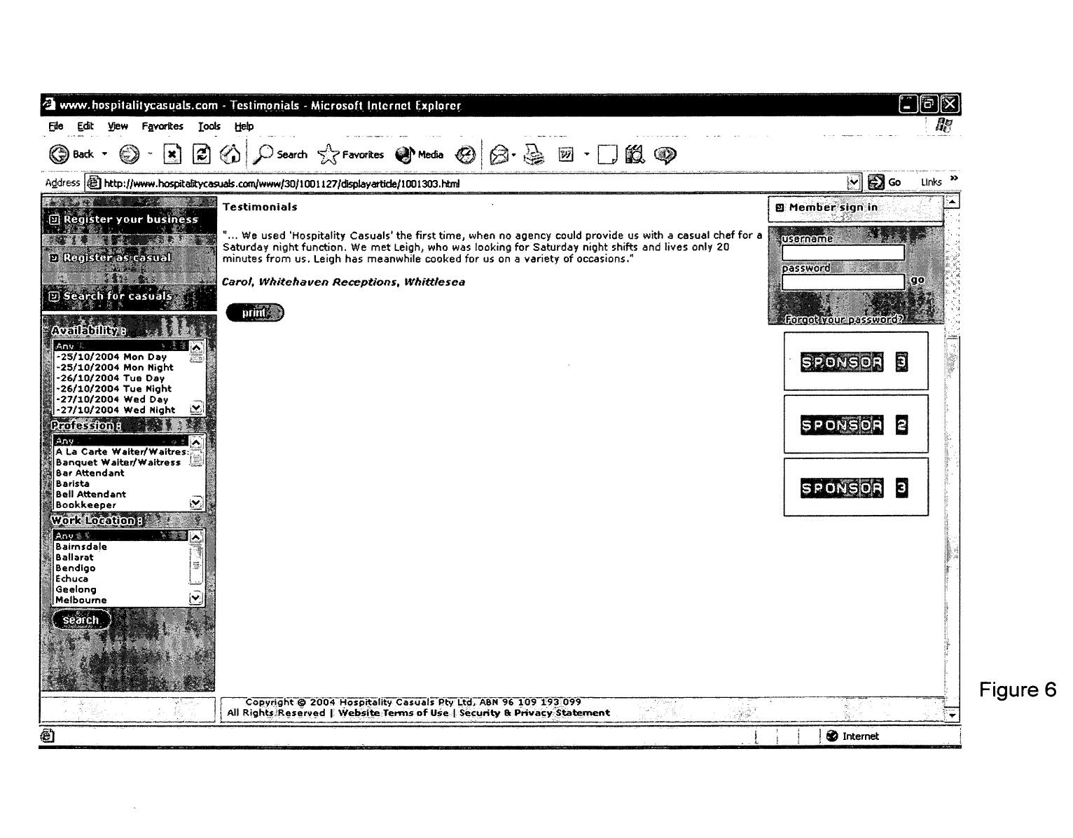

Prospective employers 110 register with the system by completing a registration form such as that shown in FIG. 5 and payment of an annual fee. Referring back to FIG. 2, the prospective employee 110 nominates search criteria including the type of casual employee 120 required, the date and/or time that the casual employee is required, and the area that the position is located in 240. An example of a suitable search criteria selection menu is shown in FIG. 6. A search engine is then instructed to interrogate the database 160 using the nominated search criteria 250. Casual employees 120 having a job seeker profile that matches the employer nominated search criteria are identified and the system generates a list of appropriate candidates 260. The list of suitable candidates includes links to each listed casual employee's job seeker profile. The prospective employer 110 then reviews the job seeker profiles and selects one or more casual employees that appear to be suitable for the position on offer 270.

When a job seeker profile is displayed to a prospective employer 110, the casual employee's location and contact details preferably remain hidden in order to maintain the privacy of the casual employee 120. Only the suburb in which the casual employee 120 lives is revealed to the prospective employer 110, to assist the employer in making a judgement as to whether the casual employee is likely to be amendable to travelling to the prospective employer's location. Since the casual employee's contact details are not revealed directly to the prospective employer, the employer contacts the job seeker using the instant communication pathway 280. Of course, the casual employee's contact details including at least a telephone number could be revealed to the prospective employee if privacy is not an issue.

It is envisaged that the instant communication could take a number of different forms. It is to be understood that it is an aspect of the invention to provide a means of communication that provides instant communication without jeopardising the confidentiality of the casual employee. One such method involves the prospective employer instructing the system to transmit a short message service (SMS) text message to the casual employee. The SMS message includes details of the position on offer such as the type of work, date, time and location of the position, together with a contact telephone number for the prospective employer. Once the message has been transmitted, the prospective employer awaits a call from the casual employee to discuss the details directly.

To ensure that the prospective employer will receive an immediate response to the job offer, if for example, the prospective employer is searching for a casual employee that is able to work a shift commencing in two hours time, it is envisaged that the prospective employer could instruct the system to automatically transmit SMS messages to a number of casual employees which meet the search criteria and include an instruction in the message for the casual employee to respond to the job offer in the next five minutes. This way, a casual employee who does not check his or her messages over the next hour will know not to respond to the prospective employer's SMS. Moreover, if an employer's user preferences dictate that the S\MS message is to be transmitted to two casual employees at a time, the message is transmitted to mobile communications devices associated with the first two casual employees on a generated list. If neither of those casual employees initiate contact with the employer in a predetermined period of time, say 5 minutes, the system can be programmed to transmit the SMS message to the next two casual employees on the list, and so on until such time that a causal employee response to the SMS message to accept the job offer, or the list of casual employees meeting the employer specified criteria is depleted.

According to another embodiment, the instant communication pathway includes an electronic mail messaging facility to enable an electronic mail or email including position details and a contact telephone number for the prospective employer to be transmitted to the casual employee. However, since an email alone may not provide instant communication (unless the casual employee happens to be checking their emails when the message is sent), an instant alert, which may be an SMS text message, is transmitted to alert the casual employee that an email message has been received. That is, the casual employee receives an SMS message on their mobile telephone advising them to check their email.

In another embodiment, the instant communication pathway includes a recorded message including details of the position and a contact telephone number for the prospective employer which is transmitted to the casual employee's mobile telephone. The job seeker retrieves the message and contacts the prospective employer to discuss the details of the position.

Alternatively, the instant communication pathway could include an interactive voice response system. In this case, when the casual employee retrieves a message transmitted to his or her mobile telephone, the casual employee is provided with the details of the position and instructed to dial “1” for example, to be connected directly to the prospective employer.

In yet another embodiment, the instant communication pathway is provided by means of an internet site which enables the prospective employer to search the job seeker database and be connected directly to a selected job seeker by telephone by activating a link associated with the selected casual employee's job seeker profile.

In another alternative embodiment, contact between the prospective employer and the job seeker is initiated by the prospective employer selecting a casual employee from the generated list of casual employees and the system transmitting the casual employee's contact details to the prospective employer in return for a fee. The system offers a number of advantages to prospective employers including that prospective employers are able to immediately see who is available for the type of work and the hours required and can make a selection based on a review of the job seeker's profiles. Moreover, it is an advantage that the prospective employer is able to contact the job seeker directly and instantly without having to deal with an intervening third party such as a recruitment agency.

In one embodiment, the system may be set up to transmit one or more reminder to the casual employee of an upcoming work session. The reminder may be transmitted to the casual employee's mobile communications device as a SMS.

It is another feature of the system that the casual employee database is essentially live and up to date. For instance, when a prospective employer offers a casual employee a position for a particular date and/or time by sending that casual employee a message using the instant communication pathway, the system updates the candidate's availability profile to indicate that the casual employee is no longer available at the nominated date and/or time. This ensures that a prospective employer has exclusive access to a candidate. If the job offer is unsuitable, the job seeker can reinstate their availability for that particular date and time by updating their availability online.

The system may provide access to certain casual employees only by a specified employee. This enables the features of the system to be offered to individual employers for the purposes of managing their casual workforce more efficiently. Access to the system may be provided via an intranet. In a similar fashion, recruitment agencies may utilise the system to manage their casual personnel. In one particular embodiment of the system, there is provided a means for monitoring the time worked by a casual employee for a particular employer. This feature which is described in more detail in the following paragraphs has particular benefit for recruitment agencies which need to monitor and record time worked so that they can correctly calculate the benefits to be paid to employees and collect fees from employers.

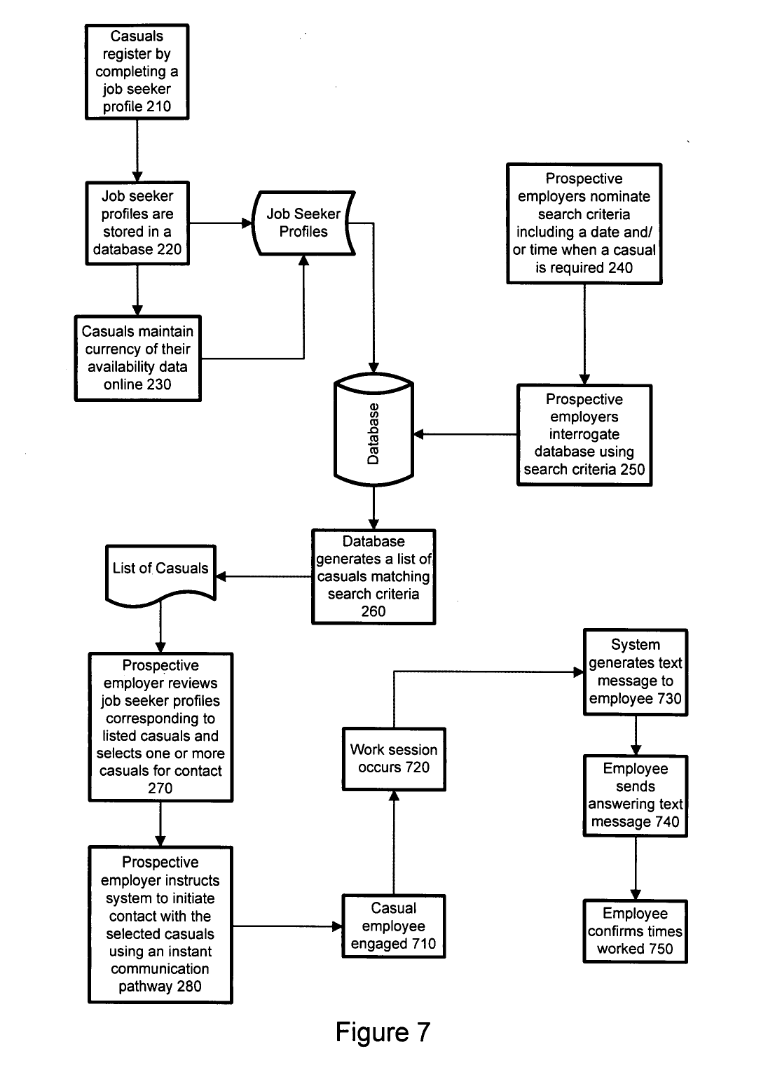

Referring now to FIG. 7, the casual employment system includes a capability for monitoring time worked by casual employees. Once a casual employee 120 has been engaged 310, and has worked one or more sessions 320, it becomes necessary for the employee 120 and the employer 110 to record details of the hours worked by the employee, so that the casual employee's benefits can be calculated correctly. This is done by arranging for the system to generate 330 a text message to the employee 120 requesting confirmation of the hours worked after a planned work session. The text message may list the hours for which the work session had been planned. The casual employee 120 then responds 340 to the text message to confirm details of the work session for recordal by the recruitment service 150. The response message might simply be a “yes” to confirm that the work session went for the hours planned, or it might include details indicating the extent to which the work session differed from the planned timing. The employer 110 also confirms 350 details of the work session.

The employer's confirmation may be by way of a code entered on a mobile communications device associated with the casual employee, such as the casual employee's mobile or cellular telephone. For example, the casual employee 120 might enter into his or her mobile telephone a text message addressed to the recruitment service 150 indicating the times worked, and the employer might enter a code into the employee's mobile telephone as part of the text message, and the code effectively acts as the employer's signature to indicate that the times submitted by the employee are correct.

In one embodiment, a reusable code is provided to the employer as part of the system registration process. In another, the employer may be provided with more than one code such that each code is suitable for single use only, or cannot be reused sequentially. The benefit of the employer being assigned more than one code being to enhance security by making it difficult for the casual employee to memorise a code entered on the worker's mobile communications device and use it dishonestly to verify time sheets.

There are numerous different ways in which the employer 110 may provide confirmation of the hours worked. Another way is by connecting to an internet website associated with the recruitment service 150, and, after entering an appropriate password, entering or selecting and confirming details of the times worked by the employee 120.

It will be appreciated that the use of text messages sent to and from the employee's mobile communications device provides a much simpler and more instant process for verification of times than do manual timesheets. Whilst it would be possible for the employee to access an internet website associated with the employment service and enter or select and confirm times worked, this may not be so convenient depending on the nature of the casual employee's employment and the availability of a computer with internet access. The use of a mobile communications device such as a mobile telephone is therefore likely to be more convenient in many cases.

Not only is use of the recruitment service for monitoring casual employee work time convenient for employers who recruit casual personnel directly using the recruitment service, but advantages are also apparent for recruitment agencies. When recruitment agencies are utilised to recruit casual personnel, accurate and prompt recordal of time worked is imperative so that the recruitment agency can charge the correct amount to the employer and as well as paying the correct benefits to the employee.

An advantage of the invention is to provide a cost effective and reliable means for businesses to recruit casual staff. It is envisaged that the system of the present invention will provide prospective employers with direct access to a bank of experienced casual workers. The method and system of the present invention also offers greater flexibility and control to casual job seekers who are able to nominate when and where they wish to work.

It is to be understood that various additions, alterations and/or modifications may be made to the parts previously described without departing from the ambit of the invention.

1. A method for recruiting and managing casual personnel via a telecommunications network, the method comprising the following steps:
(a) one or more casual employees registering a job seeker profile in a database, each job seeker profile including details of the casual employee's availability;
(b) a prospective employer nominating search criteria for interrogation of the database, the search criteria including a date and/or time when the casual employee is required to work;
(c) generating a list of casual employees having a job seeker profile that matches the employer nominated search criteria;
(d) the prospective employer selecting one or more casual employees from the list; and
(e) the prospective employer initiating contact with the selected casual employees using an instant communication pathway.

2. A method according to claim 1, wherein the prospective employer selects the one or more casual employees based on a review of the job seeker profiles.

3. A method according to claim 1, wherein contact is initiated by transmitting a message to the selected casual employees, the message prompting the casual employee to initiate contact with the prospective employer on an expedited basis.

4. A method according to claim 1, wherein the selected casual employee's contact details are transmitted to the prospective employer in return for a fee.

5. A method of recruiting and managing casual personnel via a telecommunications network, the method comprising the following steps:
(a) one or more casual employees registering a job seeker profile in a database, each job seeker profile including details of the casual employee's availability;
(b) a prospective employer nominating search criteria for interrogation of the database, the search criteria including a date and/or time when the casual employee is required to work;
(c) generating a list of casual employees having a job seeker profile that matches the employer nominated search criteria;
(d) the prospective employer initiating contact with one or more of the listed casual employees using an instant communication pathway;
(e) monitoring the time worked by the casual employee for the employer by the casual employee receiving a text message after a planned work session, the text message requesting confirmation of the time worked in the work session, the casual employee replying to the text message to confirm details of the work session, and the employer confirming details of the work session.

6. A method according to claim 5, wherein the casual employee receives and responds to the text message using a mobile communications device which receives and transmits the text messages.

7. A method according to claim 6, wherein the employer confirms details of the work session by entering a code onto the casual employee's mobile communications device.

8. A system for recruiting and managing casual personnel via a telecommunications network, the system comprising:
(a) a registration component for entering a casual employee's job seeker profile including details of the casual employee's availability;
(b) a database for storing a plurality of job seeker profiles;
(c) a search criteria selection component which enables a prospective employer to nominate search criteria for interrogation of the database, the search criteria including a date and time when the casual employee is required to work;
(d) a search engine for identifying casual employees having a job seeker profile that matches the employer nominated search criteria;
(e) a selection component to enable the prospective employer to select one or more identified casual employees that the prospective employer wishes to contact; and
(f) a communication component for initiating contact between the prospective employer and one or more selected casual employees using an instant communication pathway.

9. A system according to claim 8, wherein the instant communication pathway includes a short message service (SMS) text messaging facility to enable a text message including a contact telephone number for the prospective employer to be transmitted to the casual employee.

10. A system according to claim 8, wherein the instant communication pathway includes an electronic mail messaging facility in which a contact telephone number for the prospective employer is transmitted to the casual employee via email, with an instant alert notifying the casual employee on receipt of the email.

11. A system according to claim 8, wherein the instant communication pathway includes an interactive voice response system.

12. A system for recruiting and managing casual personnel via a telecommunications network, the system comprising:
(a) a registration component for entering a casual employee's job seeker profile including details of the casual employee's availability;
(b) a database for storing a plurality of job seeker profiles;
(c) a search criteria selection component which enables a prospective employer to nominate search criteria for interrogation of the database, the search criteria including a date and time when the casual employee is required to work;
(d) a search engine for identifying casual employees having a job seeker profile that matches the employer nominated search criteria;
(e) a communication component for initiating contact between the prospective employer and an identified casual employee using an instant communication pathway; and
(f) a monitoring component for sending a text message to the casual employee after a planned work session, receiving from the casual employee a text message to confirm details of the work session, and receiving from the employer confirmation of details of the work session.

13. A system according to claim 12, wherein the casual employee has a mobile communications device which receives and transmits the text messages.

14. A system according to claim 13, wherein the employer confirms details of the work session by entering a code onto the casual employee's mobile communications device.

15. An internet site for recruiting and managing casual personnel via the internet, comprising:
(a) a registration component for entering a casual employee's job seeker profile including details of the casual employee's availability;
(b) a database for storing a plurality of job seeker profiles;
(c) a search criteria selection component which enables a prospective employer to nominate search criteria for interrogation of the database, the search criteria including a date and time when the casual employee is required to work;
(d) a search engine for identifying casual employees having a job seeker profile and that that matches the employer nominated search criteria;
(e) a messaging component for transmitting a message using an instant communication pathway, the message prompting the casual employee to expeditiously initiate contact with the prospective employer business;
(f) a communication component enabling the casual employee to initiate contact with the prospective employer; and
(g) a monitoring component for monitoring the time worked by the casual employee for the employer.

16. An internet site according to claim 15, wherein the time worked by the casual employee for the employer is monitored by:
(a) the casual employee receiving a text message after a planned work session, the text message requesting confirmation of the time work in the work session;
(b) the casual employee replying to the text message to confirm details of the work session; and
(c) the employer confirming details of the work session.
